(19) United States
(12) Patent Application Publication
(10) Pub. No.: US 2012/0158657 A1
(43) Pub. Date: Jun. 21, 2012

(54) ROLE-SPECIFIC ACCESS CONTROL TO SECTIONS OF ARTIFACT CONTENT WITHIN A CONFIGURATION MANAGEMENT (CM) SYSTEM

(75) Inventors: HOWARD B. BERNSTEIN, LEXINGTON, MA (US); SHUBHVARDHAN MANJAYYA, BANGALORE (IN); SUJEET MISHRA, BANGALORE (IN)

(73) Assignee: INTERNATIONAL BUSINESS MACHINES CORPORATION, ARMONK, NY (US)

(21) Appl. No.: 12/974,894

(22) Filed: Dec. 21, 2010

(51) Int. Cl. G06F 17/30

(52) U.S. Cl. 707/634; 707/E17.005

(57) ABSTRACT

An artifact having at least one role-specific content section can be stored in a repository by a configuration management system. The role-specific content section can be associated with a specific role value. A request to access the stored artifact can be received. The request can include at least an identifier of a requestor, a role value of the requestor, and a version identifier of the artifact. A copy of the artifact specified in the received request can be created. The artifact copy can be modified to omit role-specific content sections inapplicable to the role value of the requestor. The modified artifact copy can be provided to the requestor.

### BACKGROUND

The present invention relates to the field of configuration management (CM) systems.

Configuration management (CM) systems are a cornerstone for managing documents, generally referred to artifacts, within many organizations. These systems act as a centralized library, enforcing access privileges and capturing the changes made to an artifact through multiple versions or revisions.

### BRIEF SUMMARY

One aspect of the disclosure can include a method, computer program product, system, and apparatus for controlling user access to sections of an artifact within a configuration management (CM) system. This aspect can store an artifact having at least one role-specific content section in a repository by a configuration management system. The role-specific content section can be associated with a specific role value. A request to access the stored artifact can be received. The request can include at least an identifier of a requestor, a role value of the requestor, and a version identifier of the artifact. A copy of the artifact specified in the received request can be created. The artifact copy can be modified to omit role-specific content sections inapplicable to the role value of the requestor. The modified artifact copy can be provided to the requestor.

Another aspect of the present invention can include a configuration management system for controlling user access to sections of an artifact within a configuration management (CM) system. The system can include a set of artifacts, a role-based storage handler, a role-based delta generator, and a role-based artifact reconstructor. The artifacts can have at least one role-specific content section, where the role-specific content section is associated with a specific role value. The role-based storage handler can capture relationships between the specific role value and the associated role-specific content section during storage of an artifact. The role-based delta generator can generate role-specific delta files representing modifications for a version of the artifact. The modification contained within a role-specific delta file can be associated with the specific role value of the role-specific content section in which a modification occurs. The role-based artifact reconstructor can provide role-specific copies of the artifact to a requestor, wherein contents of a role-specific artifact copy are restricted by a role value of the requestor.

Another aspect of the disclosure can include a method, computer program product, system, and apparatus for role-based configuration management of artifacts. The aspect can separate a configuration managed artifact in to a plurality of different sections. Role values can be associated with each of the different sections. A request can be received from a user for the configuration managed artifact. A role of the user for the request can be determined. The sections of the configuration managed artifact that corresponds to the determined role can be provided in response to the request. Other ones of the sections will not be provided to the user based on the determined role of the user.

### BRIEF DESCRIPTION OF THE SEVERAL VIEWS OF THE DRAWINGS

FIG. 1 is a conceptual illustration 100 of the basic functionality of a configuration management (CM) system that utilizes role-specific delta files in accordance with embodiments of the inventive arrangements disclosed herein.

FIG. 2 is a schematic diagram illustrating a system that utilizes role-specific content sections and role-specific delta files for artifacts of a configuration management (CM) system to provide role-specific access in accordance with an embodiment of the inventive arrangements disclosed herein.

FIG. 3 is a flow chart of a method detailing the storage of an artifact with respect to role-specific content sections in accordance with an embodiment of the inventive arrangements disclosed herein.

FIG. 4 is a flow chart of a method illustrating the provision of a role-specific artifact copy in accordance with embodiments of the inventive arrangements disclosed herein.

### DETAILED DESCRIPTION

While this centralization has improved artifact access, in the general sense (i.e., one location to look for documents within the organization), the monolithic handling of artifact content has produced additional issues. That is, conventional CM systems either provide or deny access to the artifact in its entirety; a user is unable to access only a portion of the artifact.

For example, in software development, an organization may out-source development of the graphical user interface (GUI) to a third party for a software application whose core functionality is being developed in-house. In order to ensure that the GUI interacts properly with the core functionality, the third party will require access to or key information about the core source code. Not wanting to disclosure sensitive or proprietary information, the organization could provide the third party with a copy of the core source code containing only the functions with which the GUI interacts.

Now, if internal developers modify functions that affect the GUI, their changes must be propagated to the copy given to the third party, increasing version-control overhead. If these documents become unsynchronized, then the GUI will be developed for out-of-date functions, delaying software release.

Thus, a CM system often becomes cluttered with artifacts that represent different aspects or sections of the same document. Not only does this practice consume storage space, but it also requires documentation of how the separate sections are resolved into the complete document as well as someone to manually reconstruct the document every time a new version of a section is stored.

The present invention discloses a solution for controlling user access to sections of an artifact within a configuration management system. Role values can be associated with content sections of the artifact when artifact is created or stored. Each user of the configuration management system can also have a role value assigned to them to indicate a level of access granted to them. If requesting an artifact from the configuration management system, a user can be provided with a copy of the artifact containing only the role-specific content sections that are accessible by their role value. The role value information can also be incorporated into the delta files used to represent versions of the artifact.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

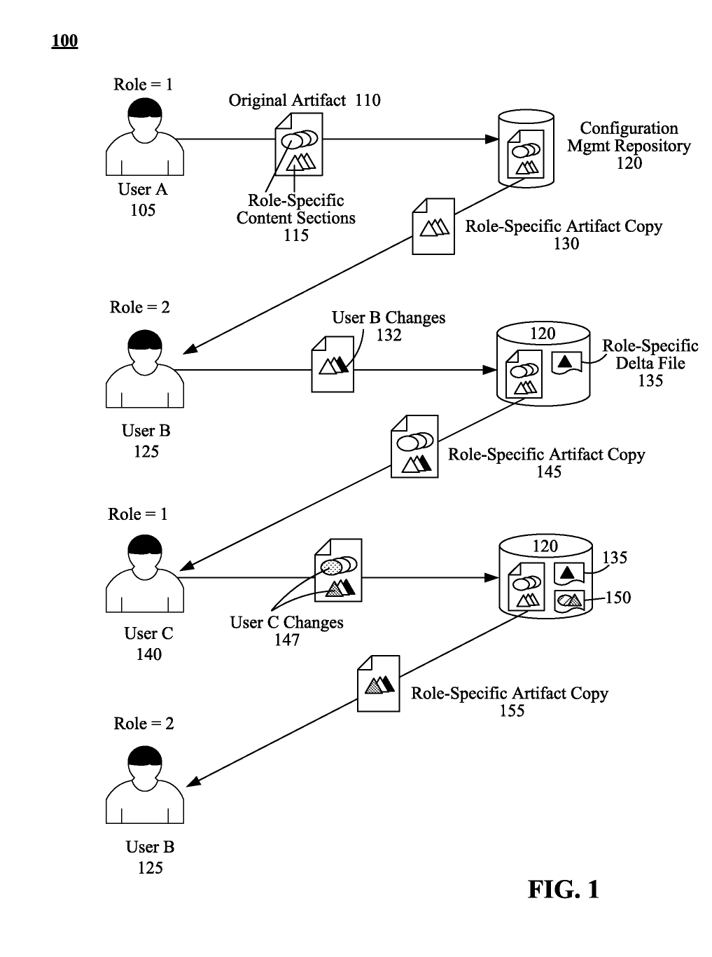

FIG. 1 is a conceptual illustration 100 of the basic functionality of a configuration management (CM) system that utilizes role-specific delta files 135 and 150 in accordance with embodiments of the inventive arrangements disclosed herein. The overall concept shown in illustration 100 can depict how roles assigned to users 105, 125, and 140 influence the data received for an artifact 110 from a configuration management repository 120.

In illustration 100, User A 105 can create and store an original artifact 110 to the configuration management repository 120. The original artifact 110 can represent a digital file conforming to one of a variety of data formats. The data contained within in the original artifact 110 can be represented by role-specific content sections 115.

A role-specific content section 115 can correspond to a logical grouping of data meant to be accessed by a user 105, 125, and 140 of a specified role value. Identifying a role-specific content section 115 can be performed via the creation tool of the original artifact 110, such as encompassing data with specially formatted annotations within a text-based document, or using the functionality of a specialized interface of the associated configuration management system.

In this example, User A 105, having a role value of one, can store an original artifact 110 within the configuration management repository 120 having six role-specific content sections 115. For the sake of this example, the three ovals can represent role-specific content sections 115 associated with a role value of one and the three triangles associated with a role value of two.

The structure of roles and how they relate to accessing content can vary based upon the specific implementation. In illustration 100, a hierarchical role structure can be exemplified where descending role values represent greater restriction in access. That is, role-specific content sections 115 associated with a role value of three can be accessed by users 105, 125, and 140 having role values equal to one, two, or three (i.e., a role value of three accesses sections 115 identified as three, a role value of two accesses sections 115 identified as two and three, and a role value of one can access all sections 115).

If User B 125 accesses the original artifact 110, User B 125 can be provided with a role-specific artifact copy 130. Since User B 125 has a role value of two, the provided role-specific artifact copy 130 can contain only role-specific content sections 115 of the original artifact 110 accessible to a role value of two. In this example, the role-specific artifact copy 130 can contain only the triangle role-specific content sections 115.

User B 125 can then make changes 132, indicated by the darkened triangle, to the role-specific artifact copy 130 and save the new version to the configuration management repository 120. If storing the new version, the configuration management system can identify the User B changes 132 and store them as a role-specific delta file 135.

Use of a delta file can be a storage technique utilized by configuration management systems to store version differences. A delta file can represent the difference between the new version being saved and a previously stored version of the artifact. By saving only the differences between consecutive versions in a delta file, the configuration management system can eliminate the storage of redundant data, minimizing the amount of storage space required for each artifact.

A role-specific delta file 135 can represent a delta file whose contents are identified by role values. For example, the role-specific delta file 135 generated for the User B changes 132 can be associated with a role value of two.

If User C 140 accesses the latest version of the original artifact 110, the configuration management system can provide User C 140 with role-specific artifact copy 145. Since User C 140 has a role value of one, the role-specific artifact copy 145 can include both the oval and triangle sections. Further, the role-specific delta file 135 can be applied to incorporate User B changes 132.

User C 140 can then make changes 147 to the role-specific content sections 115 as indicated by the dotted oval and the gray triangle. Since User C 140 has a role value of one, User C 140 can view and edit both sets of role-specific content sections 115.

If User C 140 stores the new version in the configuration management repository 120, a separate role-specific delta file 150 can be created to contain only the User C changes 147. Each User C change 147 stored in the role-specific delta file 150 can include an association with the role value of its corresponding section.

Thus, the next time that User B 125 accesses the latest version of the original artifact 110, the role-specific artifact copy 155 can reflect the only the User C change 147 made to the triangle section 115.

As used herein, presented repository 120 can be a physical or virtual storage space configured to store digital information. Repository 120 can be physically implemented within any type of hardware including, but not limited to, a magnetic disk, an optical disk, a semiconductor memory, a digitally encoded plastic memory, a holographic memory, or any other recording medium. Repository 120 can be stand-alone storage units as well as a storage unit formed from a plurality of physical devices. Additionally, information can be stored within repository 120 in a variety of manners. For example, information can be stored within a database structure or can be stored within one or more files of a file storage system, where each file may or may not be indexed for information searching purposes. Further, repository 120 can utilize one or more encryption mechanisms to protect stored information from unauthorized access.

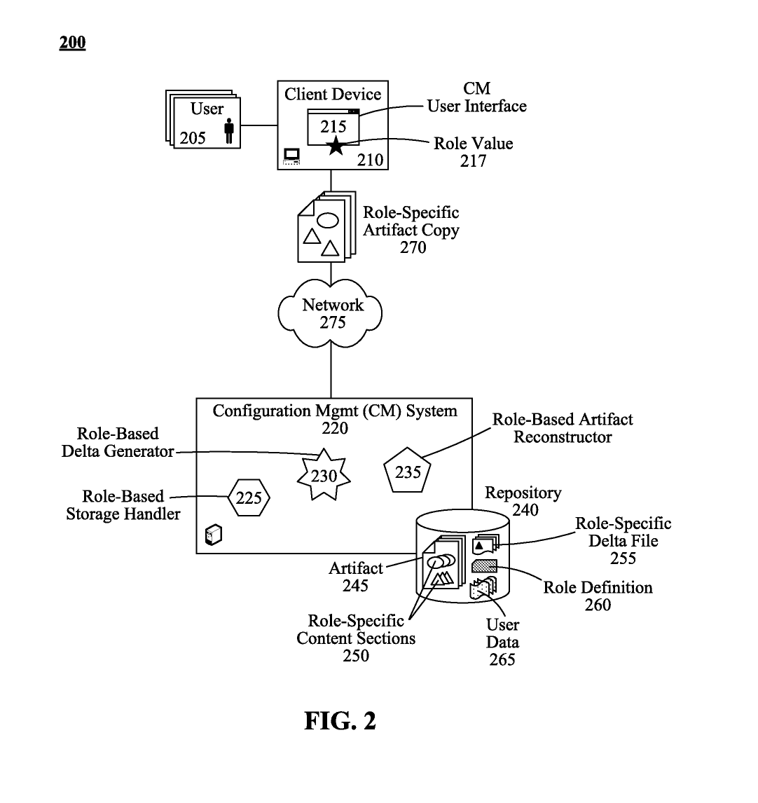

FIG. 2 is a schematic diagram illustrating a system 200 that utilizes role-specific content sections 250 and role-specific delta files 255 for artifacts 245 of a configuration management (CM) system 220 to provide role-specific access in accordance with embodiments of the inventive arrangements disclosed herein. System 200 can represent an embodiment of conceptual illustration 100.

In system 200, artifacts 245 can be created and stored with role-specific content sections 250 within a CM system 220. The CM system 220 can represent the hardware and/or software components required to provide centralized storage of, library functions for, and/or access security for various artifacts 245.

An artifact 245 can represent a digital file conforming to one of a variety of data formats. Unlike the artifacts 245 stored using conventional approaches, the artifacts 245 stored in the repository 240 of the CM system 220 shown in system 200 can include one or more role-specific content sections 250.

As previously discussed, a role-specific content section 250 can correspond to a logical grouping of data contained in the artifact 245 whose access is restricted to users 205 of a specified role value 217. It should be noted that the concept of role-based access restrictions is not uncommon within computing environments. However, application of this concept to the granular level illustrated by this embodiment of the present disclosure can be found to be lacking in conventional CM systems.

The CM system 220 can include a role-based storage handler 225, a role-based delta generator 230, a role-based artifact reconstructor 235, and a repository 240 for data storage. It should be noted that the CM system 220 can include additional functional components without deviating from the premise of this embodiment of the present disclosure, and, that those components critical for illustrating implementation of the present disclosure can be shown in system 200.

The role-based storage handler 225 can represent the component of the CM system 220 configured to ensure that the role value 217 for role-specific content sections 250 are properly captured during storage of the artifact 245. The association of a role value 217 and a role-specific content section 250 can be specified by a user 205 during the creation and/or storage of the artifact 245.

For example, a user 205 can identify a paragraph of a textual artifact 245 with a specific role value 217 by typing specially formatted annotations around the paragraph within the text editor.

Alternately, the role-based storage handler 225 can include a specialized mechanism that can be presented to the user 205 within the CM user interface 215 in which the user 205 can input role values 217 for role-specific content sections 250 of the artifact 245.

For example, if storing a video file 245, the user 205 can be presented with a specialized window within the CM user interface 215 in which role values 217 can be associated with time periods of the video 245.

The relationship between a role value 217 and its corresponding role-specific content sections 250 can be captured in a variety of ways, such as in a separate relationship table (not shown) or within metadata fields associated with the artifact 245. These relationships can be further utilized by the role-based delta generator 230 and/or role-based artifact reconstructor 235.

The role-based delta generator 230 can represent the component of the CM system 220 configured to generate a role-specific delta file 255 representing a new version of an artifact 245 that includes information regarding the role values 217 for role-specific content sections 250. The role-based delta generator 230 can function similar to the delta generators used by conventional CM systems with exception to the incorporation of the role values 217 assigned by a user 205 to the role-specific content sections 250.

Thus, a role-specific delta file 255 can include changes made to an artifact 245 as well as the role value 217 associated with either the user 205 storing the version and/or the role value 217 already assigned to the role-specific content sections 250 in which the change occurs.

The role-based artifact reconstructor 235 can correspond to the component of the CM system 220 configured to create a role-specific artifact copy 270 of the artifact 245 requested by a user 205. Similar to processes performed by conventional CM systems, the role-based artifact reconstructor 235 can apply the role-specific delta files 255 required to create the requested version to a copy of the original artifact 245 file with respect to the role values 217 of the requesting user 205 and the role-specific content sections 250, as described in conceptual illustration 100.

For example, a user 205 having a role value 217 of “Low” would receive a role-specific artifact copy 270 containing only those role-specific content sections 250 of the original artifact 245 that are accessible to the “Low” role value 217. If requesting a later version of the artifact 245, the portions of the role-specific delta files 255 required for the requested version (i.e., role-specific delta files 255 for versions one and two would be applied for a requested version of two) that are applicable to the “Low” role value 217 would be applied to the role-specific artifact copy 270.

Thus, a single, inclusive copy of the artifact 245 can be stored under version control with access to its content controlled using the role values 217 of the requesting users 205.

It should be noted that this level of access control cannot be provided by conventional CM systems, even those capable of utilizing role values 217 and/or access control lists (ACLs). A conventional CM system can only use role values 217 and/or ACLs to confirm or deny a user's 205 access to an artifact 245 in its entirety.

Therefore, controlling access to portions of an artifact 245 using a conventional CM system often requires storing the portions as separate artifacts 245. As such, each portion then generates its own versions and requires a manual process to incorporate the versions of the separate portions back into the main artifact 245. This embodiment of the present disclosure overcomes these issues by improving the granularity of access control provided by the use of role values 217 in a CM system 220.

The role value 217 of a user 205 can be stored within the user data 265 of the CM system 220. A role definition 260 can describe the structure of role values 217.

For example, a role definition 260 can define a hierarchical structure where a parent role value 217 can access the role-specific content sections 250 of all its child role values 217, but is denied access to role-specific content sections 250 of its parent role value 217.

The user 205 can interact with the CM system 220 via the CM user interface 215 running on a client device 210. Client device 210 can represent a variety of computing devices capable of running the CM user interface 212 and communicating with the CM system 230 over the network 275.

The CM user interface 212 can represent a graphical user interface (GUI) in which the user 205 can perform the various functions of the CM system 220 like checking in/out artifacts 245/role-specific artifact copies 270.

Network 275 can include any hardware/software/and firmware necessary to convey data encoded within carrier waves. Data can be contained within analog or digital signals and conveyed though data or voice channels. Network 275 can include local components and data pathways necessary for communications to be exchanged among computing device components and between integrated device components and peripheral devices. Network 275 can also include network equipment, such as routers, data lines, hubs, and intermediary servers which together form a data network, such as the Internet. Network 275 can also include circuit-based communication components and mobile communication components, such as telephony switches, modems, cellular communication towers, and the like. Network 275 can include line based and/or wireless communication pathways.

As used herein, presented repository 240 can be a physical or virtual storage space configured to store digital information. Repository 240 can be physically implemented within any type of hardware including, but not limited to, a magnetic disk, an optical disk, a semiconductor memory, a digitally encoded plastic memory, a holographic memory, or any other recording medium. Repository 240 can be stand-alone storage units as well as a storage unit formed from a plurality of physical devices. Additionally, information can be stored within repository 240 in a variety of manners. For example, information can be stored within a database structure or can be stored within one or more files of a file storage system, where each file may or may not be indexed for information searching purposes. Further, repository 240 can utilize one or more encryption mechanisms to protect stored information from unauthorized access.

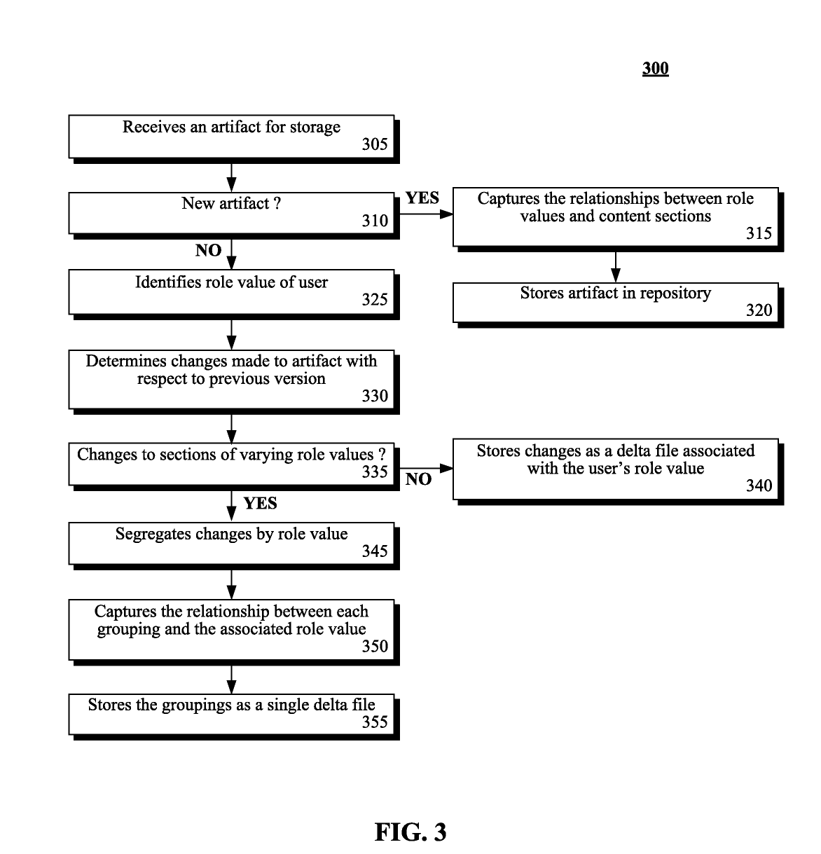

FIG. 3 is a flow chart of a method 300 detailing the storage of an artifact with respect to role-specific content sections in accordance with embodiments of the inventive arrangements disclosed herein. Method 300 can be performed within the context of system 200 and/or any other CM system configured to control access to sections of artifact content based on the role value of users.

Method 300 can begin in step 305 where the CM system can receive an artifact for storage. It should be noted that the role-specific artifact copy received by a user is considered an artifact of the CM system, and that the use of the term “copy” is used for the sake of clarity between the original artifact and the role-modified version provided to the user.

It can be determined if the received artifact is new to the CM system in step 310. If the received artifact is new to the CM system, step 315 can execute where the relationships between role values and content sections of the artifact can be captured. In step 320, the artifact can then be stored in the repository.

If the received artifact is not new to the CM system (i.e., a new version of an existing artifact), the role value of the user can be identified in step 325. In step 330, the changes made to the artifact with respect to the previous version can be determined.

In step 335, it can be determined if the identified changes were made to sections of the artifact having varying role values. If the changes were not made to sections of varying role values, the changes can be stored as a delta file associated with the user's role value in step 340 (i.e., the user can only access sections akin to his own role value, therefore any changes are applicable only to the user's role value).

It should be noted that the determination of step 335 can be of import only in an embodiment of the present disclosure in which role values are structured hierarchically. That is, in a flat structure (i.e., a user is strictly limited to sections of their role value), then a situation cannot arise where a user is able to make changes to sections with varying role values. Since such a structure is severely limiting, the more robust hierarchical structure for role values can be illustrated in this example as well as other Figures.

If the changes were made to sections of varying role values, then step 345 can execute where the changes can be segregated by role value. The relationship between each grouping and the associated role value can be captured in step 350. In step 355, the groupings can be stored as a single delta file.

As an alternate to step 355, each grouping can be stored as a separate delta file (i.e., one delta file for each role value grouping).

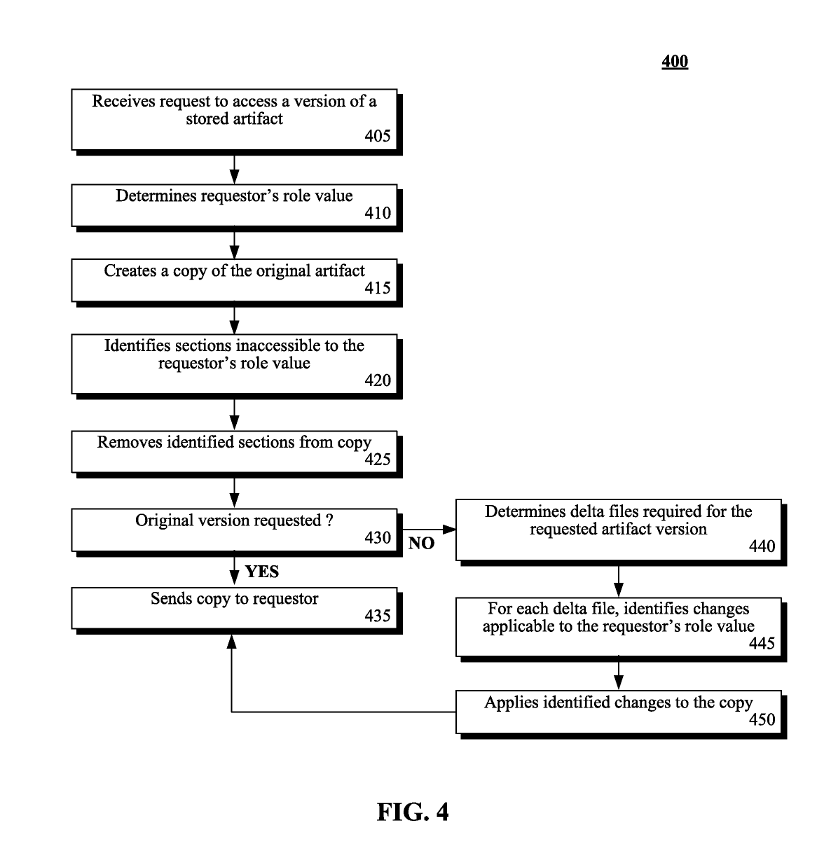

FIG. 4 is a flow chart of a method 400 illustrating the provision of a role-specific artifact copy in accordance with embodiments of the inventive arrangements disclosed herein. Method 400 can be performed within the context of system 200 and/or in conjunction with method 300.

Method 400 can begin in step 405 where the CM system can receive a request to access a version of a stored artifact. The user's role value can be determined in step 410. In step 415, a copy of the original artifact can be created.

Sections of the artifact inaccessible to the user's role value can be identified in step 420. In step 425, the identified sections can be removed from the copy. In step 430, it can be determined if the original version of the artifact was requested.

If the original version of the artifact has been requested, the artifact copy can be sent to the requestor in step 435. If a version other than the original has been requested, flow of method 400 can proceed to step 440 where the delta files required to construct the requested version of the artifact can be determined.

For each delta file, the changes applicable to the requestor's role value can be identified in step 445. In step 450, the identified changes from the delta file can be applied to the artifact copy. Flow of method 400 can then proceed to step 435 where the copy is sent to the requestor.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method comprising:
storing an artifact having at least one role-specific content section in a repository by a configuration management system, wherein the at least one role-specific content section is associated with a specific role value;
receiving a request to access the stored artifact, wherein said request comprises at least an identifier of a requestor, a role value of the requestor, and a version identifier of the artifact;
creating a copy of the artifact specified in the received request;
modifying the artifact copy to omit role-specific content sections inapplicable to the role value of the requestor; and
providing the modified artifact copy to the requestor.

2. The method of claim 1, wherein storage of the artifact further comprises:
determining a version of the artifact; and
if the version indicates that the artifact is new to the configuration management system, capturing at least one relationship between the at least one role-specific content section and its specific role value.

3. The method of claim 2, further comprising:
if the version indicates that the artifact is a new version of an existing artifact, identifying the role value of an entity having initiated storage of the artifact;
determining at least one modification made to the artifact with respect to a latest-stored version of the artifact;
ascertaining the role value of the determined at least one modification based upon the role value of the role-specific content section in which the at least one modification has been made;
capturing at least one relationship between the at least one modification and its ascertained role value; and
storing the identified modifications as a delta file of the artifact.

4. The method of claim 3, wherein, if a plurality of role values are ascertained for a corresponding plurality of modifications, said method further comprising:
segregating modifications by role value; and
storing each segregated group of modifications as a separate delta file for the artifact.

5. The method of claim 1, wherein storage of the artifact further comprises:
presenting a user interface to an entity having initiated storage of the artifact, wherein, within said user interface, role values are entered for association with the at least one role-specific content section of the artifact.

6. The method of claim 1, wherein modification of the artifact copy further comprises:
if the version identifier of the request indicates a version other than an original form of the artifact, determining at least one delta file required to produce the version;
identifying modifications contained within the at least one delta file applicable to the role value of the requestor; and
sequentially applying the identified modifications of the at least one determined delta file to the artifact copy.

7. The method of claim 1, wherein the configuration management system comprises:
a plurality of artifacts including the stored at least one artifact, each having at least one role-specific content section, wherein the at least one role-specific content section is associated with a specific role value;
a role-based storage handler configured to capture relationships between the specific role value and the associated role-specific content section during storage of an artifact;
a role-based delta generator configured to generate role-specific delta files representing modifications for a version of the artifact, wherein modification contained within a role-specific delta file are associated with the specific role value of the role-specific content section in which a modification occurs; and
a role-based artifact reconstructor configured to provide role-specific copies of the artifact to a requestor, wherein the modified artifact copy is one of the role-specific copies provided by the role-based artifact reconstructor.

8. A method comprising:
separating a configuration managed artifact in to a plurality of different sections;
associating role values with each of the different sections;
receiving a request from a user for the configuration managed artifact;
determining a role of the user for the request; and
providing the sections of the configuration managed artifact that corresponds to the determined role of the user to the user in response to the request and not providing other ones of the sections to the user based on the determined role of the user.

9. The method of claim 8, wherein the request is referable to as a first request, wherein the role is referable to as a first role, and wherein the user is referable to as a first user, said method further comprising:
receiving a second request from a second user for the configuration managed artifact, wherein the second request is a different request from the first request, wherein the second user is a different user than the first user;
determining a second role of the second user for the second request; and
providing the sections of the configuration managed artifact that corresponds to the second role of the second user to the second user in response to the second request and not providing other ones of the sections to the second user based on the determined second role of the second user, wherein the sections presented to the first user are different than the sections presented to the second user.

10. The method of claim 8, wherein the request is referable to as a first request, and wherein the role is referable to as a first role, wherein said user has a plurality of different roles, comprising the first role and the first role, said method further comprising:
receiving a second request from the user for the configuration managed artifact;
determining a second role of the user for the second request; and
providing the sections of the configuration managed artifact that corresponds to the determined second role of the user to the user in response to the second request and not providing other ones of the sections to the user based on the determined second role of the second user, wherein the sections presented responsive to the first request are different than the sections presented responsive to the second request.

11. The method of claim 8, wherein the configuration management artifact is managed by a configuration management system, said configuration management system comprising:
a plurality of artifacts, each having at least one role-specific content section, wherein the at least one role-specific content section is associated with a specific role value;
a role-based storage handler configured to capture relationships between the specific role value and the associated role-specific content section during storage of an artifact;
a role-based delta generator configured to generate role-specific delta files representing modifications for a version of the artifact, wherein modification contained within a role-specific delta file are associated with the specific role value of the role-specific content section in which a modification occurs; and
a role-based artifact reconstructor configured to provide role-specific copies of the artifact to a requestor, wherein contents of a role-specific artifact copy are restricted by a role value of the requestor, and wherein said user is the requestor to which the role-based artifact reconstructor provides a role-specific copy of the artifact, wherein the provided sections of the configuration managed artifact that corresponds to the determined role are provided within the role-specific copy provided by the role-based artifact reconstructor.

12. The method of claim 8, further comprising:
storing the configuration managed artifact in a repository by a configuration management system, wherein the different sections of the configuration managed artifact are each role-specific content sections that are each associated with a specific role value, wherein the received request is to access the stored configuration managed artifact comprises at least an identifier of a user referred to as the requestor, a role value of the requestor, and a version identifier of the artifact;
creating a copy of the artifact specified in the received request;
modifying the artifact copy to omit role-specific content sections inapplicable to the role value of the requestor; and
providing the modified artifact copy that comprises the sections that correspond to the determined role and that lacks the other ones of the sections.

13. The method of claim 12, wherein storage of the artifact further comprises:
determining a version of the artifact; and
if the version indicates that the artifact is new to the configuration management system, capturing at least one relationship between the at least one role-specific content section and its specific role value.

14. A configuration management system comprising:
a plurality of artifacts having at least one role-specific content section, wherein the at least one role-specific content section is associated with a specific role value;
a role-based storage handler configured to capture relationships between the specific role value and the associated role-specific content section during storage of an artifact;
a role-based delta generator configured to generate role-specific delta files representing modifications for a version of the artifact, wherein modification contained within a role-specific delta file are associated with the specific role value of the role-specific content section in which a modification occurs; and
a role-based artifact reconstructor configured to provide role-specific copies of the artifact to a requestor, wherein contents of a role-specific artifact copy are restricted by a role value of the requestor.

15. The system of claim 14, further comprising:
a plurality of user data defining a role value for each registered user;
a role definition defining structure and usage of role values;
a data repository for storing the plurality of artifacts, the role-specific delta files created by the role-based delta generator, the plurality of user data, and the role definition.

16. A computer program product comprising a computer readable storage medium having computer usable program code embodied therewith, the computer usable program code comprising:
computer usable program code that upon being executed by a processor is operable to store an artifact having at least one role-specific content section in a repository by a configuration management system, wherein the at least one role-specific content section is associated with a specific role value;
computer usable program code that upon being executed by a processor is operable to receive a request to access the stored artifact, wherein said request comprises at least an identifier of a requestor, a role value of the requestor, and a version identifier of the artifact;
computer usable program code that upon being executed by a processor is operable to create a copy of the artifact specified in the received request;
computer usable program code that upon being executed by a processor is operable to modify the artifact copy to omit role-specific content sections inapplicable to the role value of the requestor; and
computer usable program code that upon being executed by a processor is operable to provide the modified artifact copy to the requestor.

17. The computer program product of claim 16, further comprising:
computer usable program code that upon being executed by a processor is operable to determine a version of the artifact; and
computer usable program code that upon being executed by a processor is operable to, if the version indicates that the artifact is new to the configuration management system, capture at least one relationship between the at least one role-specific content section and its specific role value.

18. The computer program product of claim 17, further comprising:
computer usable program code that upon being executed by a processor is operable to, if the version indicates that the artifact is a new version of an existing artifact, identify the role value of an entity having initiated storage of the artifact;
computer usable program code that upon being executed by a processor is operable to determine at least one modification made to the artifact with respect to a latest-stored version of the artifact;
computer usable program code that upon being executed by a processor is operable to ascertain the role value of the determined at least one modification based upon the role value of the role-specific content section in which the at least one modification has been made;
computer usable program code that upon being executed by a processor is operable to capture at least one relationship between the at least one modification and its ascertained role value; and
computer usable program code that upon being executed by a processor is operable to store the identified modifications as a delta file of the artifact.

19. The computer program product of claim 18, wherein, if a plurality of role values are ascertained for a corresponding plurality of modifications, said computer program product further comprising:
computer usable program code that upon being executed by a processor is operable to segregate modifications by role value; and
computer usable program code that upon being executed by a processor is operable to store each segregated group of modifications as a separate delta file for the artifact.

20. The computer program product of claim 16, further comprising:
computer usable program code that upon being executed by a processor is operable to present a user interface to an entity having initiated storage of the artifact, wherein, within said user interface, role values are entered for association with the at least one role-specific content section of the artifact.
